(19) United States
(12) Patent Application Publication
(10) Pub. No.: US 2007/0095595 A1
(43) Pub. Date: May 3, 2007

(54) Anti-squeeze method utilizing airbag information

(75) Inventor: Laurent Cheramy, Vieilles-Maisons-sur-Joudry (FR)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Light Vehicle Systems-France

(21) Appl. No.: 11/264,989

(22) Filed: Nov. 2, 2005

(51) Int. Cl. B60K 28/12

(52) U.S. Cl. 180/281

(57) ABSTRACT

An anti-squeeze control utilizes information provided by a safety restraint system, such as an airbag system for example, to control window raising speed and/or a squeeze detection threshold in a vehicle. The airbag system includes a plurality of occupant sensors that generate data related to weight and size of a vehicle occupant. A controller identifies whether the vehicle occupant is an adult or child based on data from the occupant sensors. If a child is identified, the anti-squeeze control activates a high safety level where at least one of window raising speed and a squeeze detection threshold is reduced to allow reversal before reaching high pinching forces.

### TECHNICAL FIELD

An anti-squeeze control utilizes information provided by airbag system sensors to initiate a high safety level of operation for window movement control once a child is identified within a vehicle.

### BACKGROUND OF THE INVENTION

Children can be left momentarily in a vehicle or can be playing inside a vehicle, while the vehicle is parked or while the vehicle is in some type of non-driving mode of operation. The children are often able to release seatbelts such that they are able to move within a passenger compartment area. Sometimes these children are able to insert a key within a vehicle ignition or are able to activate other types of vehicle systems by using keyless entry. This could have unfortunate consequences.

If a child is playing inside a vehicle and manages to activate a window closing mechanism for example, the child could have a head, neck, arm, fingers, or other body parts pinched between a moving window pane and a vehicle frame member. This could cause serious injury to the child.

Many different anti-squeeze control systems have been proposed to address this problem. These systems often do not work effectively to provide desired window movement control for various different operational conditions. One proposed solution reduces a pinch detection threshold for a motor that raises a window. However, when the vehicle is driving, especially when experiencing rough road conditions, there are vertical accelerations of the vehicle and the windows. Having a reduced pinch detection threshold in these circumstances could cause undesired reversing of window movement.

Another proposed solution is to reduce raising speed of the window for certain conditions. This allows the amount of window travel to be reduced between pinching detection and actual window movement reversal. Reduced raising speed can be applied when the vehicle is stationary, for example. However, an adult may view slow movement of the window, which is an associated result of having a reduced pinch detection threshold, as a potential system failure.

Thus, there is a need for a simple and effective method to identify when a child is playing within a vehicle such that certain vehicle operations, such as raising windows for example, can be performed at higher safety levels to prevent injury to the child.

### SUMMARY OF THE INVENTION

An anti-squeeze control utilizes information provided by a safety restraint system, such as an adaptive, i.e. “smart,” airbag system for example, to vary at least one of window raising speed and a squeezing detection threshold in accordance with vehicle occupant type. The airbag system includes at least one occupant sensor that generates data related to at least one of a weight and size of a vehicle occupant. When a vehicle is equipped with a smart airbag system, a controller utilizes this available data concerning weight and/or size of the vehicle occupant to vary deployment conditions of an airbag based on occupant type. The subject anti-squeeze control uses this already available data to identify whether the vehicle occupant is an adult or child for anti-squeeze purposes. If a child is identified, the anti-squeeze controller modifies window driving and/or pinching threshold parameters to allow reversal before high pinching forces are reached.

The anti-squeeze control has a high safety level and a standard safety level. The high safety level is activated when the vehicle occupant is classified in the child classification, and the standard safety level is activated when the vehicle occupant is classified in the adult classification. The high safety level is defined as having a first maximum allowable window raising speed and a first maximum allowable pinching force, and the standard safety level is defined as having a second maximum allowable window raising speed and a second maximum allowable pinching force. The first maximum allowable window raising speed is less than the second maximum allowable window raising speed and the first maximum allowable pinching force is less than the second maximum allowable pinching force. The anti-squeeze control reverses a window direction of movement when either the first or second maximum allowable pinching force is exceeded.

The anti-squeeze control utilizes existing occupant sensor data from an airbag system to identify whether or not a child is playing in a vehicle when the vehicle is not in motion. Once a child is identified, the anti-squeeze control operates at high safety level to prevent the child from suffering an injury resulting from having appendages pinched or caught between a window pane and a vehicle frame member, if the child is somehow able to initiate movement of window panes toward a closed position. The controller information could also be used to prohibit the vehicle from being started, or prevent a parking brake from being released, if only a child is identified in the vehicle when the vehicle is in a non-driving mode of operation.

These and other features of the present invention can be best understood from the following specification and drawings, the following of which is a brief description.

### BRIEF DESCRIPTION OF THE DRAWINGS

FIG. 1 is a schematic view of a vehicle having an anti-squeeze control incorporating the subject invention.

FIG. 2 is a schematic side view of a vehicle door with a movable window pane.

FIG. 3 is a schematic end view of the vehicle door of FIG. 2 showing a potential pinching of an object between the movable window pane and a frame member.

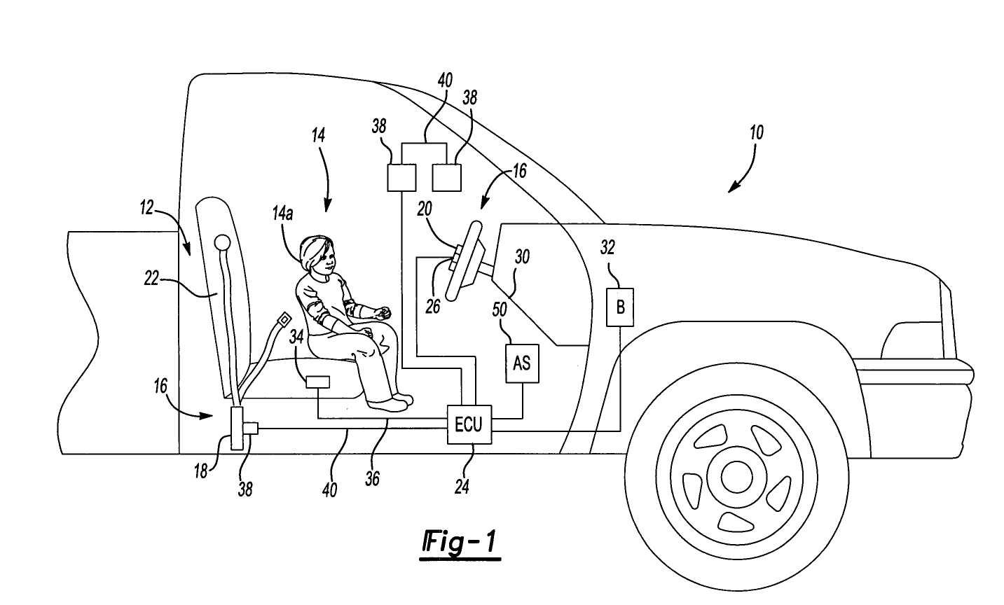

### DETAILED DESCRIPTION OF THE PREFERRED EMBODIMENT

A vehicle 10 encloses a passenger compartment 12. Vehicle occupants 14 (only one is shown) can occupy the passenger compartment 12 during non-driving modes of operation for various reasons. For example, a child 14a can be left in a running vehicle 10 while a parent or adult is outside the vehicle 10. Or, the child 14a could enter a vehicle without adult permission or knowledge. In either event, the child 14a could intentionally or inadvertently activate certain vehicle systems that could be potentially harmful to the child 14a, or to others if the child 14a initiates movement of the vehicle 10.

The vehicle 10 includes a safety restraint system 16 that is used to prevent or reduce injuries to vehicle occupants 14 during collisions or other impact events. The safety restraint system 16 includes a seatbelt assembly 18 and an airbag system 20. The seatbelt assembly 18 is used to secure a vehicle occupant 14 to a vehicle seat 22. The airbag system 20 is deployed under predetermined collision conditions to prevent the vehicle occupant 14 from impacting vehicle components such as a steering wheel, instrument panel, or console, for example.

The airbag system 20 is in communication with a vehicle or system electronic control unit (ECU) 24, and can control deployment force of an airbag 26, or can prevent deployment, based on vehicle occupant size, weight, and/or proximity to an instrument panel 30 as known. The airbag system 20 utilizes a plurality of sensors that generate occupant signals to determine such information as occupant weight, size, and position within the passenger compartment 12. A power source 32, such as a vehicle battery for example, provides power to operate the sensors and the ECU 24 when the vehicle is in a driving or non-driving mode of operation.

Many different types of sensors can be used to generate data for the vehicle occupant 14. In one example, at least one weight sensor 34 is associated with the vehicle seat 22. The weight sensor 34 transmits a weight signal 36 to the ECU 24, which determines vehicle occupant weight based on the weight signal 36. Other sensors from the airbag system 20, such as occupant position and/or or seatbelt sensors 38, can also be utilized to generate vehicle occupant data. The occupant position and seatbelt sensors 38 also generate occupant signals 40 that are transmitted to the ECU 24, which determines occupant position within the vehicle 10 based on the signals 40. Any type of weight sensor or occupant sensor suitable for a restraint system, and which can be used to determine occupant morphology, can be used.

The ECU 24 uses data from the occupant signals 40 and the weight signal 36 to classify the type of vehicle occupant 14 that is in the vehicle. The ECU 24 can use the occupant signals 40 to determine position and/or size of the vehicle occupant. The ECU 24 could also compare the measured weight to a predetermined weight level or threshold to determine whether or not the vehicle occupant 14 is a child. An example of one predetermined weight threshold is approximately thirty kilograms (30 kg). If the ECU 24 determines that the weight of the vehicle occupant 14 is less than the predetermined weight threshold, or that the size of the vehicle occupant 14 is smaller than a predetermined size, the ECU 24 classifies the vehicle occupant as a child. If the ECU 24 determines that the weight of the vehicle occupant 14 is greater than the predetermined weight threshold, or that the size of the vehicle occupant 14 is greater than a predetermined size, the ECU 24 classifies the vehicle occupant as an adult.

Thirty kilograms is just one example of a predetermined weight threshold. It should be understood that while two weight and/or size classifications are discussed as an example (one above and one below a threshold), additional classifications could also be utilized. For example, the predetermined weight and size thresholds could be comprised of multiple weight and size thresholds to provide multiple classifications, such as infant, toddler, small child, large child, small adult, large adult, etc. The ECU 24 could then make control decisions based on what type of occupant is found within the vehicle 10.

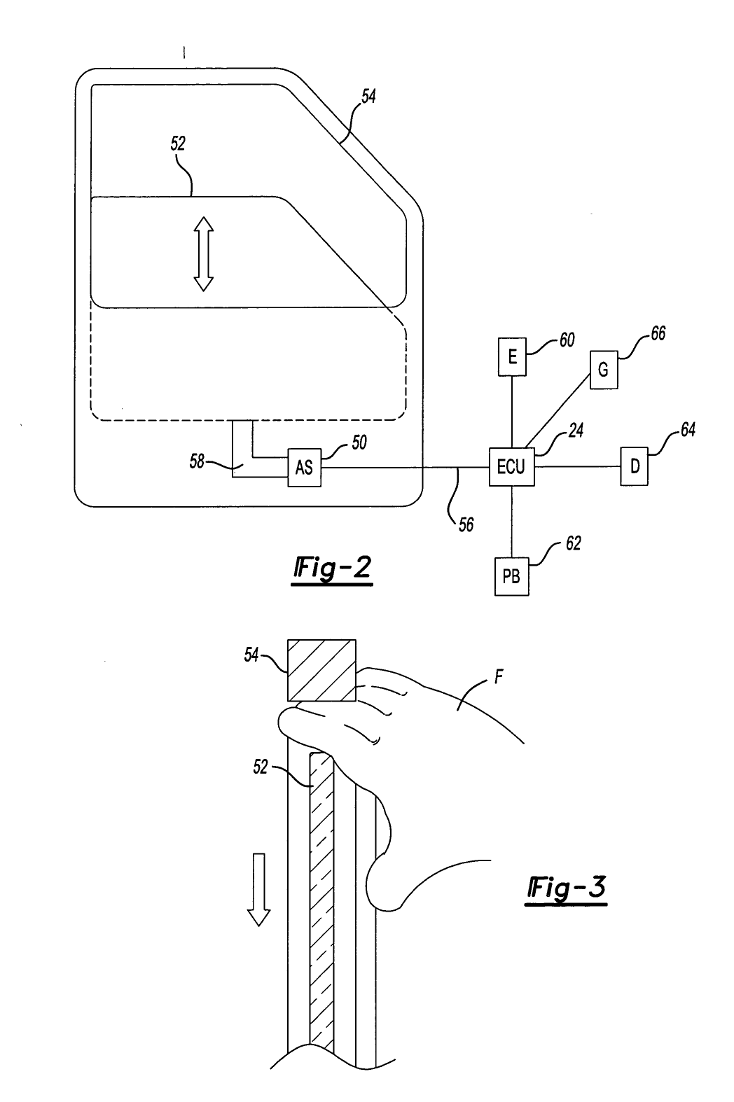

The vehicle 10 also includes an anti-squeeze control 50, see FIGS. 2 and 3, that is used to prevent an object, such as a finger F for example, from being pinched between a window pane 52 and a frame member 54 as the window pane 52 moves toward a closed position. The anti-squeeze control 50 is in communication with the ECU 24. If the ECU 24 determines that a child 14a is in the vehicle 10, the ECU 24 transmits a signal 56 to the anti-squeeze control 50, which causes the anti-squeeze control 50 to change operating characteristics for a window regulator 58.

The window regulator 58 includes a moving mechanism such as a motor (not shown) that is coupled to the window pane 52 to move the window pane 52 between raised and lowered positions. Raising speed of the window pane 52 correlates to a pinching force that is generated when an object is placed in the path of the moving window pane 52. Once a pinching force is generated, the motor can be reversed to move the window pane 52 back toward the lowered position. Once the anti-squeeze control 50 determines that an object is caught, a certain period of time is necessary to allow movement of the window pane 52 to be braked and stopped before reversing movement. During this period of time, the pinching force keeps rising. Sometimes, if the raising speed of the window pane 52 is high, this pinching force can be very high, and the anti-squeeze control 50 may not be able to reverse the direction of window pane movement quickly enough to avoid injury.

The anti-squeeze control 50 of the present invention has at least a high safety level and a standard safety level that are activated based on vehicle occupant type. The anti-squeeze control 50 utilizes existing sensor data from the airbag system 20 to classify whether the vehicle occupant 14 is an adult or a child. The high safety level is activated when the vehicle occupant 14 is classified in a child classification and the standard safety level is activated when the vehicle occupant 14 is classified in an adult classification.

The high safety level is defined as having a first maximum allowable window raising speed and a first maximum allowable pinching force, and the standard safety level is defined as having a second maximum allowable window raising speed and a second maximum allowable pinching force. The first maximum allowable window raising speed is less than the second maximum allowable window raising speed and the first maximum allowable pinching force is less than the second maximum allowable pinching force. The anti-squeeze control 50 reverses a window direction of movement when either the first or second maximum allowable pinching force is exceeded. However, injury to children is prevented by modifying squeeze control operational characteristics to keep the raising speed and maximum allowable pinching forces as low as possible once a child is identified in the vehicle 10.

As an alternative, the high safety level is defined as having a first maximum allowable pinching force threshold before reversing window movement, and the standard safety level is defined as having a second maximum allowable pinching force threshold before reversing window movement. The first maximum allowable pinching force threshold is less than the second maximum allowable pinching force threshold. The anti-squeeze control 50 reverses a window direction of movement when either the first or second maximum allowable pinching force threshold is exceeded.

Optionally, a combination of window raising speed and maximum allowable pinching force thresholds could be used to define the high and standard safety levels. The high safety level would have a window raising speed that is less than the window raising speed for the standard safety level. The high safety level would also have a maximum allowable pinching force threshold that would be lower than that of the standard safety level. The anti-squeeze control 50 controls window raising speed in combination with reversing a direction of movement of the window when the maximum allowable pinching forces for either the high or standard safety level is exceeded.

In any of the embodiments described above, injury to children is prevented by modifying squeeze control operational characteristics to keep the maximum allowable pinching forces as low as possible once a child 14a is identified in the vehicle 10.

The anti-squeeze control 50 utilizes existing occupant sensor data from the airbag system 20 to identify whether or not a child is playing in the vehicle 10, which typically occurs when the vehicle is not in motion, i.e. parked with ignition on or off. Once a child is identified, the anti-squeeze control 50 operates at the high safety level to prevent the child from suffering from an injury resulting from having appendages pinched or caught between the window pane 52 and the frame member 54, if the child is somehow able to initiate window pane movement toward a closed position.

The ECU 24 could also be used to prevent an engine 60, see FIG. 2, from being started, and/or prevent a parking brake 62 from being released, and/or a gear position to be modified by a gear selector 66 once a child is identified in the vehicle. These types of situations could occur when the vehicle is parked or in a non-driving mode with the ignition on or off. If at least one adult is in the vehicle with at least one child, the system may detect an adult in the vehicle and will not enter into the high safety level. If the system has classified a small adult as a child, a high safety level deactivation mechanism 64 can be activated to allow the adult to start the engine 60, release the parking brake 62, and/or move the gear selector 66 to engage transmission gears. The deactivation mechanism 64 could be a hidden button, touch screen, lever, or a key cylinder such as for deactivating a front passenger air bag when a child seat is on a front passenger seat, for example. A dedicated warning light on a vehicle dashboard could be used to indicate when the high safety level is deactivated, or an on-board computer could be used to generate messages that the high safety level is deactivated.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method for controlling an activation of a vehicle function controller comprising the steps of:
(a) classifying a vehicle occupant into one of a plurality of classifications including at least an adult classification and a child classification using available information from an airbag control system; and
(b) entering a high safety level if a child is identified and entering a standard safety level if an adult is identified.

2. The method according to claim 1 wherein the vehicle function controller comprises an anti-squeeze function controller of a powered member movable relative to a frame.

3. The method according to claim 2 wherein the high safety level includes at least one of a first closing speed and a first pinching force detection threshold, and the standard safety level includes at least one of a second closing speed and a second pinching force detection threshold, the first closing speed being less than the second closing speed and the first pinching force detection threshold being less than the second pinching force detection threshold.

4. The method according to claim 2 wherein the powered member comprises a window pane.

5. The method according to claim 1 wherein the vehicle function controller comprises a parking brake release controller and including the step of prohibiting release of a parking brake when operating in the high safety level.

6. The method according to claim 1 wherein the vehicle function controller comprises an engine starting controller and including the step of prohibiting start-up of an engine when operating in the high safety level.

7. The method according to claim 1 wherein the vehicle function controller comprises a transmission gear selector controller and including the step of prohibiting a change in gear selector position when operating in the high safety level.

8. The method according to claim 1 wherein the airbag control system includes at least one occupant sensor and wherein step (a) includes generating an occupant signal from the at least one occupant sensor to identify at least one of a weight and size of the vehicle occupant.

9. An electronic control unit for controlling an activation of a vehicle function controller comprising:
at least one input that receives occupant information from an airbag control system, wherein the electronic control unit classifies a vehicle occupant into one of a plurality of classifications based on the occupant information from the airbag control system, and wherein the plurality of classifications includes at least an adult classification and a child classification; and
at least one output to a vehicle function controller wherein the electronic control unit activates a high safety level for the vehicle function controller if the vehicle occupant is in the child classification and activates a standard safety level for the vehicle function controller if the vehicle occupant is in the adult classification.

10. The electronic control unit according to claim 9 wherein the vehicle function controller comprises an anti-squeeze control system that controls a powered member that is movable relative to a frame, and wherein the high safety level includes at least one of a first closing speed and a first pinching force detection threshold, and the standard safety level includes at least one of a second closing speed and a second pinching force detection threshold, the first closing speed being less than the second closing speed and the first pinching force detection threshold being less than the second pinching force detection threshold.

11. The electronic control unit according to claim 9 wherein the vehicle function controller comprises a park brake release controller to control a release of a park brake, and wherein the electronic control unit prohibits a release of the park brake when in the high safety level.

12. The electronic control unit according to claim 9 wherein the vehicle function controller comprises an engine starting controller to control starting of an engine, and wherein the electronic control unit prohibits the engine from starting when in the high safety level.

13. The electronic control unit according to claim 9 wherein the vehicle function controller comprises a transmission gear selector controller to control a selector of a transmission gear, and wherein the electronic control unit prohibits the selector from changing a transmission gear position when in the high safety level.

14. The electronic control unit according to claim 9 wherein the airbag control system includes at least one occupant sensor that generates an occupant signal from the at least one occupant sensor to identify at least one of a weight and size of the vehicle occupant, and wherein the electronic control unit classifies the vehicle occupant based on the occupant signal.

15. An anti-squeeze control system for controlling a powered member that moves relative to a frame comprising:
at least one input that receives occupant information from an airbag control system; and
an electronic control unit that classifies a vehicle occupant based on the occupant information from the airbag control system, with the electronic control unit classifying the vehicle occupant into one of a plurality of classifications including at least an adult classification having a standard safety level and a child classification having a high safety level, the high safety level including at least one of a first closing speed and a first pinching force detection threshold, and the standard safety level including at least one of a second closing speed and a second pinching force detection threshold, wherein the first closing speed is less than the second closing speed and the first pinching force detection threshold is less than the second pinching force detection threshold, and wherein the electronic control unit controls movement of the powered member based on classification of the vehicle occupant.

16. The anti-squeeze control system according to claim 15 further comprising at least one output to a vehicle function controller to communicate safety level information to the vehicle function controller.

17. The anti-squeeze control system according to claim 16 wherein the vehicle function controller comprises a park brake release controller to control a release of a park brake, and wherein the electronic control unit prohibits a release of the park brake when in the high safety level.

18. The anti-squeeze control system according to claim 16 wherein the vehicle function controller comprises an engine starting controller to control starting of an engine, and wherein the electronic control unit prohibits the engine from starting when in the high safety level.

19. The anti-squeeze control system according to claim 16 wherein the vehicle function controller comprises a transmission gear selector controller to control a selector of a transmission gear, and wherein the electronic control unit prohibits the selector from changing a transmission gear position when in the high safety level.

20. The anti-squeeze control system according to claim 16 wherein the airbag control system includes at least one occupant sensor that generates an occupant signal from the at least one occupant sensor to identify at least one of a weight and size of the vehicle occupant, and wherein the electronic control unit classifies the vehicle occupant based on the occupant signal.
